(19) United States
(12) Patent Application Publication
(10) Pub. No.: US 2016/0246228 A1
(43) Pub. Date: Aug. 25, 2016

(54) FIXING DEVICE AND IMAGE FORMING APPARATUS

(71) Applicants: Ippei FUJIMOTO, Kanagawa (JP); Kenji ISHll, Kanagawa (JP); Kazuhito KISHI, Kanagawa (JP); Kazunari SAWADA, Tokyo (JP); Takashi SETO, Kanagawa (JP); Susumu MATSUSAKA, Kanagawa (JP); Yasuhiko OGINO, Kanagawa (JP); Shohta KOBASHIGAWA, Tokyo (JP); Hiromasa TAKAGI, Tokyo (JP); Takamasa HASE, Tokyo (JP); Hiroshi YOSHINAGA, Chiba (JP)

(72) Inventors: Ippei FUJIMOTO, Kanagawa (JP); Kenji ISHll, Kanagawa (JP); Kazuhito KISHI, Kanagawa (JP); Kazunari SAWADA, Tokyo (JP); Takashi SETO, Kanagawa (JP); Susumu MATSUSAKA, Kanagawa (JP); Yasuhiko OGINO, Kanagawa (JP); Shohta KOBASHIGAWA, Tokyo (JP); Hiromasa TAKAGI, Tokyo (JP); Takamasa HASE, Tokyo (JP); Hiroshi YOSHINAGA, Chiba (JP)

(21) Appl. No.: 15/013,827

(22) Filed: Feb. 2, 2016

(30) Foreign Application Priority Data
Feb. 23, 2015 (JP) 2015-032685

(51) Int. Cl. G03G 15/20

(52) U.S. Cl. CPC G03G 15/2053

(57) ABSTRACT

A fixing device includes a first heater and a second heater to heat a fixing rotator. The first heater includes a first heat generator having a first heating span in a longitudinal direction of the first heater and a first support supporting the first heat generator. The second heater includes a second heat generator having a second heating span in a longitudinal direction of the second heater and a second support supporting the second heat generator. A screen screens one of the first heater and the second heater from another one of the first heater and the second heater. At least one of the first support and the second support is disposed in proximity to a lateral end of at least one of the first heat generator and the second heat generator in the longitudinal direction of the first heater and the second heater.

### CROSS-REFERENCE TO RELATED APPLICATION

This patent application is based on and claims priority pursuant to 35 U.S.C. §119 to Japanese Patent Application No. 2015-032685, filed on Feb. 23, 2015, in the Japanese Patent Office, the entire disclosure of which is hereby incorporated by reference herein.

### BACKGROUND

1. Technical Field

Exemplary aspects of the present disclosure relate to a fixing device and an image forming apparatus, and more particularly, to a fixing device for fixing a toner image on a recording medium and an image forming apparatus incorporating the fixing device.

2. Description of the Background

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such fixing device may include a fixing rotator, such as a fixing roller, a fixing belt, and a fixing film, heated by a heater and a pressure rotator, such as a pressure roller and a pressure belt, pressed against the fixing rotator to form a fixing nip therebetween through which a recording medium bearing a toner image is conveyed. As the recording medium bearing the toner image is conveyed through the fixing nip, the fixing rotator and the pressure rotator apply heat and pressure to the recording medium, melting and fixing the toner image on the recording medium.

### SUMMARY

This specification describes below an improved fixing device. In one exemplary embodiment, the fixing device includes a fixing rotator rotatable in a predetermined direction of rotation and a pressure rotator pressed against the fixing rotator to form a fixing nip therebetween, through which a recording medium bearing a toner image is conveyed. A first heater is disposed opposite an inner circumferential surface of the fixing rotator to heat the fixing rotator. The first heater includes a first heat generator having a first heating span in a longitudinal direction of the first heater to generate heat and a first support supporting the first heat generator. A second heater is disposed opposite the inner circumferential surface of the fixing rotator to heat the fixing rotator. The second heater includes a second heat generator having a second heating span in a longitudinal direction of the second heater to generate heat and a second support supporting the second heat generator. A screen is interposed between the first heater and the second heater to screen one of the first heater and the second heater from another one of the first heater and the second heater. At least one of the first support and the second support is disposed in proximity to a lateral end of at least one of the first heat generator and the second heat generator in the longitudinal direction of the first heater and the second heater.

This specification further describes an improved image forming apparatus. In one exemplary embodiment, the image forming apparatus includes an image bearer to bear a toner image and a fixing device disposed downstream from the image bearer in a recording medium conveyance direction to fix the toner image on a recording medium. The fixing device includes a fixing rotator rotatable in a predetermined direction of rotation and a pressure rotator pressed against the fixing rotator to form a fixing nip therebetween, through which the recording medium bearing the toner image is conveyed. A first heater is disposed opposite an inner circumferential surface of the fixing rotator to heat the fixing rotator. The first heater includes a first heat generator having a first heating span in a longitudinal direction of the first heater to generate heat and a first support supporting the first heat generator. A second heater is disposed opposite the inner circumferential surface of the fixing rotator to heat the fixing rotator. The second heater includes a second heat generator having a second heating span in a longitudinal direction of the second heater to generate heat and a second support supporting the second heat generator. A screen is interposed between the first heater and the second heater to screen one of the first heater and the second heater from another one of the first heater and the second heater. At least one of the first support and the second support is disposed in proximity to a lateral end of at least one of the first heat generator and the second heat generator in the longitudinal direction of the first heater and the second heater.

### BRIEF DESCRIPTION OF THE DRAWINGS

A more complete appreciation of the disclosure and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an exemplary embodiment of the present disclosure;

FIG. 2 is a schematic vertical sectional view of a fixing device according to an exemplary embodiment of the present disclosure that is incorporated in the image forming apparatus shown in FIG. 1;

FIG. 3 is a plan view of a comparative halogen heater;

FIG. 4A is a partial horizontal sectional view of the fixing device shown in FIG. 2 illustrating a first halogen heater and a second halogen heater;

FIG. 4B is a partial vertical sectional view of the fixing device shown in FIG. 4A;

FIG. 5 is a schematic vertical sectional view of a fixing device according to another exemplary embodiment of the present disclosure;

FIG. 6A is a partial horizontal sectional view of the fixing device shown in FIG. 5;

FIG. 6B is a partial vertical sectional view of the fixing device shown in FIG. 6A;

FIG. 7A is a partial horizontal sectional view of a fixing device as a modification example of the fixing devices shown in FIGS. 2 and 5;

FIG. 7B is a partial vertical sectional view of the fixing device shown in FIG. 7A;

FIG. 8A is a partial horizontal sectional view of a fixing device as another modification example of the fixing devices shown in FIGS. 2 and 5; and

FIG. 8B is a partial vertical sectional view of the fixing device shown in FIG. 8A.

### DETAILED DESCRIPTION OF THE DISCLOSURE

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner and achieve a similar result.

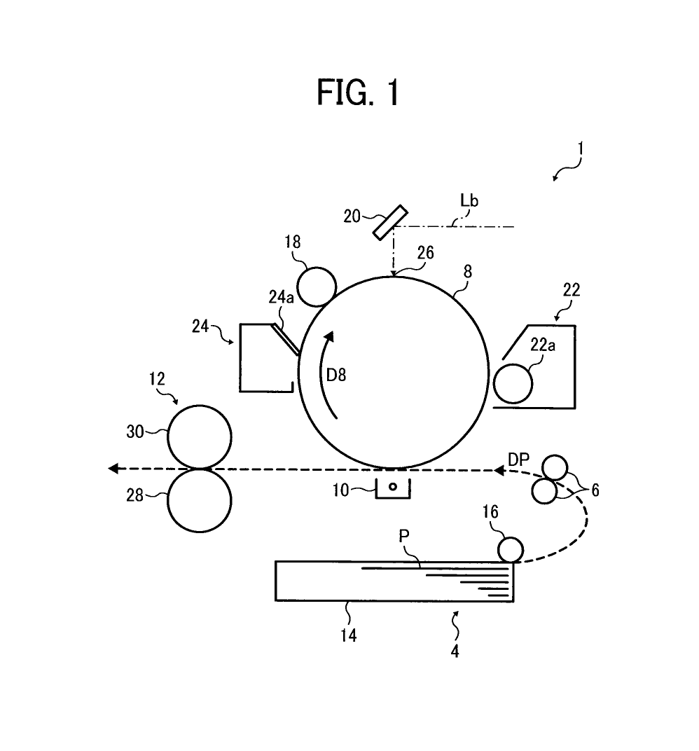

Referring now to the drawings, wherein like reference numerals designate identical or corresponding parts throughout the several views, in particular to FIG. 1, an image forming apparatus 1 according to an exemplary embodiment of the present disclosure is explained.

It is to be noted that, in the drawings for explaining exemplary embodiments of this disclosure, identical reference numerals are assigned, as long as discrimination is possible, to components such as members and component parts having an identical function or shape, thus omitting description thereof once it is provided.

FIG. 1 is a schematic vertical sectional view of the image forming apparatus 1. The image forming apparatus 1 may be a copier, a facsimile machine, a printer, a multifunction peripheral or a multifunction printer (MFP) having at least one of copying, printing, scanning, facsimile, and plotter functions, or the like. According to this exemplary embodiment, the image forming apparatus 1 is a monochrome printer that forms a monochrome toner image on a recording medium by electrophotography. Alternatively, the image forming apparatus 1 may be a color printer that forms a color toner image on a recording medium.

As shown in FIG. 1, the image forming apparatus 1 includes a sheet feeder 4, a registration roller pair 6, a photoconductive drum 8 serving as an image bearer, a transfer device 10, and a fixing device 12.

The sheet feeder 4 includes a paper tray 14 that loads a plurality of sheets P serving as recording media and a feed roller 16 that picks up an uppermost sheet P from the plurality of sheets P loaded on the paper tray 14 and feeds the uppermost sheet P to the registration roller pair 6. The registration roller pair 6 temporarily halts the sheet P sent from the feed roller 16 to correct skew of the sheet P and conveys the sheet P to a transfer nip formed between the photoconductive drum 8 and the transfer device 10 at a time in synchronism with rotation of the photoconductive drum 8, that is, at a time when a leading edge of a toner image formed on the photoconductive drum 8 corresponds to a predetermined position in a leading end of the sheet P in a sheet conveyance direction DP.

The photoconductive drum 8 is surrounded by a charging roller 18 serving as a charger, a mirror 20 constituting a part of an exposure device, a developing device 22 incorporating a developing roller 22a, the transfer device 10, and a cleaner 24 incorporating a cleaning blade 24a, which are disposed in this order clockwise in FIG. 1 in a rotation direction D8 of the photoconductive drum 8. A light beam Lb reflected by the mirror 20 irradiates and scans the photoconductive drum 8 at an exposure position 26 thereon interposed between the charging roller 18 and the developing device 22 in the rotation direction D8 of the photoconductive drum 8.

As the photoconductive drum 8 starts rotating, the charging roller 18 uniformly charges an outer circumferential surface of the photoconductive drum 8. The exposure device emits a light beam Lb onto the charged outer circumferential surface of the photoconductive drum 8 at the exposure position 26 thereon according to image data sent from an external device such as a client computer, thus forming an electrostatic latent image on the photoconductive drum 8. The electrostatic latent image formed on the photoconductive drum 8 moves in accordance with rotation of the photoconductive drum 8 to an opposed position thereon disposed opposite the developing device 22 where the developing device 22 supplies toner to the electrostatic latent image on the photoconductive drum 8, visualizing the electrostatic latent image as a toner image. As the toner image formed on the photoconductive drum 8 reaches the transfer nip, the toner image is transferred onto a sheet P conveyed from the paper tray 14 and entering the transfer nip at a predetermined time by a transfer bias applied by the transfer device 10. The sheet P bearing the toner image is conveyed to the fixing device 12 where a fixing belt 30 and a pressure roller 28 fix the toner image on the sheet P under heat and pressure. Thereafter, the sheet P bearing the fixed toner image is ejected onto an output tray disposed outside a body of the image forming apparatus 1 to stack the sheet P.

As residual toner failed to be transferred onto the sheet P at the transfer nip and therefore remaining on the photoconductive drum 8 moves under the cleaner 24 in accordance with rotation of the photoconductive drum 8, the cleaning blade 24a scrapes the residual toner off the photoconductive drum 8, thus cleaning the photoconductive drum 8. Thereafter, a discharger disposed opposite the photoconductive drum 8 removes residual potential on the photoconductive drum 8, rendering the photoconductive drum 8 to be ready for a next image forming operation.

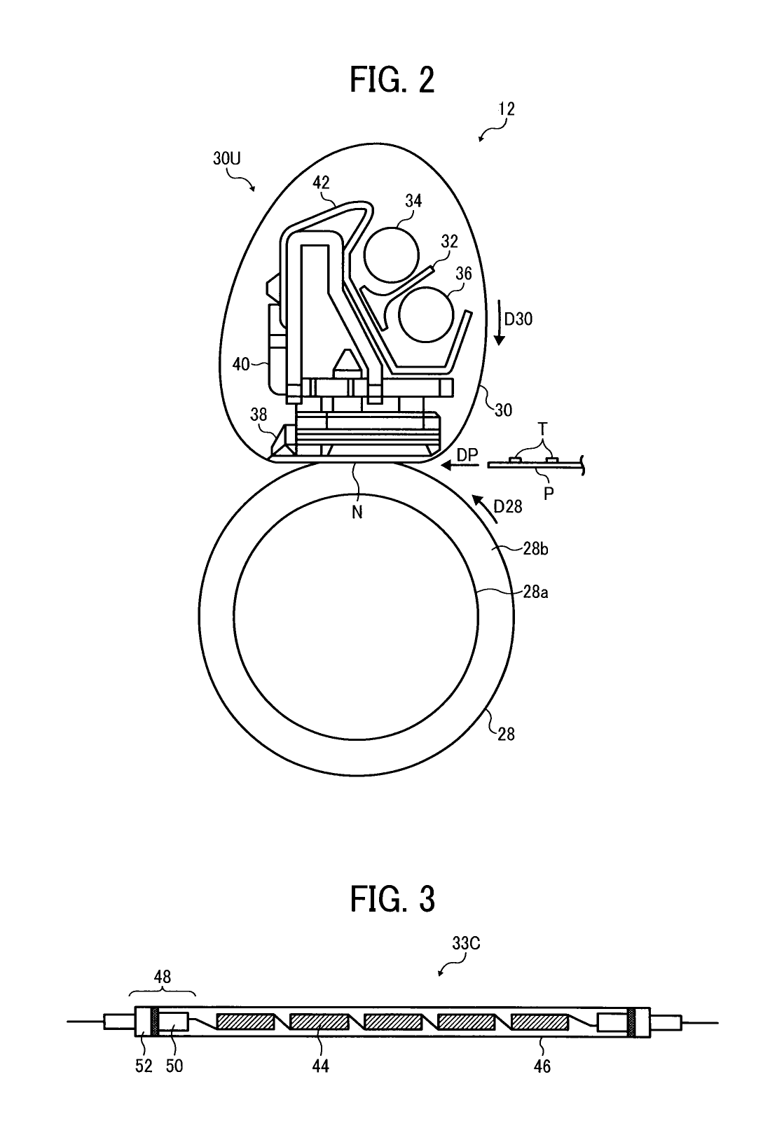

With reference to FIG. 2, a description is provided of a construction of the fixing device 12 incorporated in the image forming apparatus 1 having the construction described above.

FIG. 2 is a schematic vertical sectional view of the fixing device 12. As shown in FIG. 2, the fixing device 12 (e.g., a fuser or a fusing unit) includes the pressure roller 28 serving as a pressure rotator rotatable in a rotation direction D28 and the flexible fixing belt 30 serving as a fixing rotator or an endless belt formed into a loop and rotatable in a rotation direction D30. Inside the loop formed by the fixing belt 30 are two halogen heaters, that is, a first halogen heater 34 and a second halogen heater 36 serving as a heater or a heat source to heat the fixing belt 30 with light irradiating an inner circumferential surface of the fixing belt 30. A screen 32 is interposed between the first halogen heater 34 and the second halogen heater 36 to screen the first halogen heater 34 from the second halogen heater 36 and screen the second halogen heater 36 from the first halogen heater 34.

The first halogen heater 34 and the second halogen heater 36 have different heating spans or different heat distributions, respectively, in a longitudinal direction of the first halogen heater 34 and the second halogen heater 36 parallel to an axial direction of the fixing belt 30. For example, the first halogen heater 34 is a center heater having a center heating span of 217 mm in the longitudinal direction of the first halogen heater 34 and being transferred with electric power of 770 W. The second halogen heater 36 is a lateral end heater having a lateral end heating span of 63 mm at each lateral end of the second halogen heater 36 in the longitudinal direction thereof, thus having a combined heating span of 126 mm. The second halogen heater 36 is transferred with electric power of 440 W. Each of the first halogen heater 34 and the second halogen heater 36 includes a filament light emitter and a sealing. Since the screen 32 screens the first halogen heater 34 from the second halogen heater 36, the screen 32 prevents the filament light emitter of one of the first halogen heater 34 and the second halogen heater 36 from heating the sealing of another one of the first halogen heater 34 and the second halogen heater 36.

A nip formation pad 38 is disposed inside the loop formed by the fixing belt 30 and disposed opposite the inner circumferential surface of the fixing belt 30. The nip formation pad 38 is disposed opposite the pressure roller 28 via the fixing belt 30 to form a fixing nip N between the fixing belt 30 and the pressure roller 28. As the fixing belt 30 rotates in the rotation direction D30, the inner circumferential surface of the fixing belt 30 slides over the nip formation pad 38 directly or indirectly via a slide sheet (e.g., a low-friction sheet). As shown in FIG. 2, the fixing nip N is planar. Alternatively, the fixing nip N may be contoured into a recess or other shapes. If the fixing nip N defines a recess, the recessed fixing nip N directs a leading edge of the sheet P toward the pressure roller 28 as the sheet P is ejected from the fixing nip N, facilitating separation of the sheet P from the fixing belt 30 and suppressing jamming of the sheet P between the fixing belt 30 and the pressure roller 28.

A detailed description is now given of a construction of the pressure roller 28.

The pressure roller 28 separably contacts an outer circumferential surface of the fixing belt 30. The pressure roller 28 is constructed of a cored bar 28a, an elastic rubber layer 28b coating the cored bar 28a, and a surface release layer coating the elastic rubber layer 28b and made of tetrafluoroethylene-perfluoroalkylvinylether copolymer (PFA) or polytetrafluoroethylene (PTFE) to facilitate separation of the sheet P from the pressure roller 28. As a driving force generated by a driver (e.g., a motor) situated inside the image forming apparatus 1 depicted in FIG. 1 is transmitted to the pressure roller 28 through a gear train, the pressure roller 28 rotates in the rotation direction D28 as shown in FIG. 2. Alternatively, the driver may also be connected to the fixing belt 30 to drive and rotate the fixing belt 30. A spring or the like presses the pressure roller 28 against the nip formation pad 38 via the fixing belt 30. As the spring presses and deforms the elastic rubber layer 28b of the pressure roller 28, the pressure roller 28 produces the fixing nip N having a predetermined length in the sheet conveyance direction DP. A pressurization assembly (e.g., a spring) that presses the pressure roller 28 against the nip formation pad 38 via the fixing belt 30 releases pressure between the pressure roller 28 and the fixing belt 30 as needed to separate the pressure roller 28 from the fixing belt 30.

The pressure roller 28 may be a hollow roller. If the pressure roller 28 is a hollow roller, a heater such as a halogen heater may be disposed inside the hollow roller. The elastic rubber layer 28b may be made of solid rubber. Alternatively, if no heater is situated inside the pressure roller 28, the elastic rubber layer 28b may be made of sponge rubber. The sponge rubber has an increased insulation that draws less heat from the fixing belt 30 compared to the solid rubber.

A detailed description is now given of a construction of the fixing belt 30.

The fixing belt 30 is a thin belt or film made of metal such as nickel and SUS stainless steel or resin such as polyimide. The fixing belt 30 is constructed of a base layer and a release layer. The release layer constituting an outer surface layer is made of PFA, PTFE, or the like to facilitate separation of toner of a toner image T on the sheet P from the fixing belt 30, thus preventing the toner of the toner image T from adhering to the fixing belt 30. An elastic layer may be sandwiched between the base layer and the release layer and made of silicone rubber or the like. If the fixing belt 30 does not incorporate the elastic layer, the fixing belt 30 has a decreased thermal capacity that improves fixing property of being heated quickly to a desired fixing temperature at which the toner image T is fixed on the sheet P properly. However, as the pressure roller 28 and the fixing belt 30 sandwich and press the unfixed toner image T on the sheet P passing through the fixing nip N, slight surface asperities of the fixing belt 30 may be transferred onto the toner image T on the sheet P, resulting in variation in gloss of the solid toner image T that may appear as an orange peel image on the sheet P. To address this circumstance, the elastic layer made of silicone rubber has a thickness not smaller than 100 micrometers. As the elastic layer deforms, the elastic layer absorbs slight surface asperities of the fixing belt 30, preventing formation of the faulty orange peel image.

As the pressure roller 28 rotates in the rotation direction D28, the fixing belt 30 rotates in the rotation direction D30 in accordance with rotation of the pressure roller 28 by friction therebetween. At the fixing nip N, the fixing belt 30 rotates as it is sandwiched between the pressure roller 28 and the nip formation pad 38; at a circumferential span of the fixing belt 30 other than the fixing nip N, the fixing belt 30 rotates as it is guided by a flange serving as a holder mounted on a side plate of the fixing device 12 or located inside a frame of the fixing device 12 at each lateral end of the fixing belt 30 in the axial direction thereof.

A support 40 (e.g., a stay) that supports the nip formation pad 38 is situated inside the loop formed by the fixing belt 30 and disposed opposite the inner circumferential surface of the fixing belt 30. As the nip formation pad 38 receives pressure from the pressure roller 28, the support 40 supports the nip formation pad 38 to prevent bending of the nip formation pad 38 and produce an even nip length in the sheet conveyance direction DP throughout the entire width of the fixing belt 30 in the axial direction thereof. The support 40 is mounted on and held by the side plate of the fixing device 12 or the flange serving as the holder at each lateral end of the support 40 in a longitudinal direction thereof parallel to the axial direction of the fixing belt 30, thus being positioned inside the fixing device 12.

A reflector 42 is interposed between the two heaters (e.g., the first halogen heater 34 and the second halogen heater 36) and the support 40 to reflect light radiated from the first halogen heater 34 and the second halogen heater 36 to the reflector 42 toward the fixing belt 30, preventing the support 40 from being heated by the first halogen heater 34 and the second halogen heater 36 with radiation heat and thereby reducing waste of energy. Alternatively, instead of installation of the reflector 42, an opposed face of the support 40 disposed opposite the first halogen heater 34 and the second halogen heater 36 may be treated with insulation or mirror finish to reflect light radiated from the first halogen heater 34 and the second halogen heater 36 to the support 40 toward the fixing belt 30.

The screen 32 is mounted on and held by the side plate of the fixing device 12 or the flange serving as the holder at each lateral end of the screen 32 in a longitudinal direction thereof parallel to the axial direction of the fixing belt 30. A surface of the screen 32 is also treated with insulation or mirror finish to reflect light radiated from the first halogen heater 34 and the second halogen heater 36 to the screen 32 toward the fixing belt 30. The fixing belt 30 and the components disposed inside the loop formed by the fixing belt 30, that is, the screen 32, the first halogen heater 34, the second halogen heater 36, the nip formation pad 38, the support 40, and the reflector 42, may constitute a belt unit 30U separably coupled with the pressure roller 28.

A description is provided of a construction of a comparative fixing device.

The comparative fixing device is requested to shorten a warm-up time defining a time taken to warm up the comparative fixing device from an ambient temperature to a predetermined temperature (e.g., a reload temperature) at which printing is available after an image forming apparatus incorporating the comparative fixing device is powered on and reduce power consumption. To address those requests, the comparative fixing device shortens a waiting time for a user to wait until printing starts after the image forming apparatus is powered on and decreases power consumption during a standby time to wait for a print job. The comparative fixing device may include a heater, such as a ceramic heater and a halogen heater, to heat a thin fixing belt directly. The heater configured to heat the fixing belt directly increases the temperature of the fixing belt quickly. However, a non-conveyance span of the fixing belt where a sheet is not conveyed may overheat because the sheet does not draw heat from the non-conveyance span of the fixing belt. To address this circumstance, a plurality of heaters having different heating spans or different heat distributions, respectively, may be employed. The plurality of heaters is energized according to the size of a sheet, thus heating sheets of various sizes.

If the comparative fixing device includes a plurality of halogen heaters disposed inside a loop formed by the fixing belt, the halogen heaters may be screened from each other to prevent light emitted from one of the halogen heaters from heating a glass tube of another one of the halogen heaters. For example, the plurality of halogen heaters disposed inside the loop formed by an endless heating belt is disposed opposite each other via a reinforcement of a pressure pad that presses the heating belt against a pressure roller. The reinforcement is coupled with a reflector disposed opposite the halogen heaters. An inner circumferential surface of the heating belt slides over a guide of the pressure pad. The reinforcement projects from the guide beyond the halogen heaters. The reinforcement prevents the halogen heaters from heating the glass tubes thereof each other with light, reducing an amount of heat absorbed by the glass tubes to heat the heating belt effectively so as to shorten the warm-up time and prevent the shortened life of the halogen heaters due to overheating.

However, the glass tube has an increased thermal capacity compared to the thin fixing belt. Accordingly, the glass tube is requested to be shortened to eliminate redundancy.

A description is provided of a construction of a comparative halogen heater 33C.

FIG. 3 is a plan view of the comparative halogen heater 33C. As shown in FIG. 3, the comparative halogen heater 33C includes a filament light emitter 44; a glass tube 46 accommodating the filament light emitter 44 and containing filler gas; and a sealing 48 sealing the glass tube 46. The filament light emitter 44 serving as a heat generator includes a tungsten wire coiled at a predetermined interval. The number of coiling of the tungsten wire, the interval of coiling, and the like define the light emission intensity. The filler gas is produced by mixing a slight amount of a halogen substance such as iodine and bromine with inert gas such as nitrogen. The filler gas suppresses thermal vaporization of the tungsten wire, extending the life of the tungsten wire. The sealing 48 serving as a support that supports the heat generator includes a molybdenum foil 50 and a cement portion 52 that seal the glass tube 46.

As the sealing 48 overheats, sealing of the sealing 48 is destroyed, causing faulty power supply and leakage of the filler gas that may shorten the life of the comparative halogen heater 33C. To address this circumstance, the temperature of the sealing 48 is 35 degrees centigrade or lower.

In order to heat the fixing belt 30 evenly throughout the entire width of the fixing belt 30 in the axial direction thereof, the filament light emitter 44 of one comparative halogen heater 33C is disposed opposite the filament light emitter 44 of another comparative halogen heater 33C with a decreased interval therebetween. However, unless the screen 32 depicted in FIG. 2 is interposed between the two comparative halogen heaters 33C, the sealing 48 disposed outboard from the filament light emitter 44 in a longitudinal direction of the comparative halogen heater 33C may be heated. That is, if the glass tube 46 of each comparative halogen heater 33C is shortened without the screen 32, the sealing 48 may suffer from heating. To address this circumstance, the glass tube 46 is elongated to each lateral end of the fixing belt 30 that is outboard from the filament light emitter 44 in the axial direction of the fixing belt 30 to prevent the filament light emitter 44 of one comparative halogen heater 33C from heating the sealing 48 of another comparative halogen heater 33C. However, the elongated glass tube 46 may increase waste of heat.

A description is provided of a construction of the first halogen heater 34 and the second halogen heater 36 of the fixing device 12 to address the above-described circumstances of the comparative halogen heater 33C.

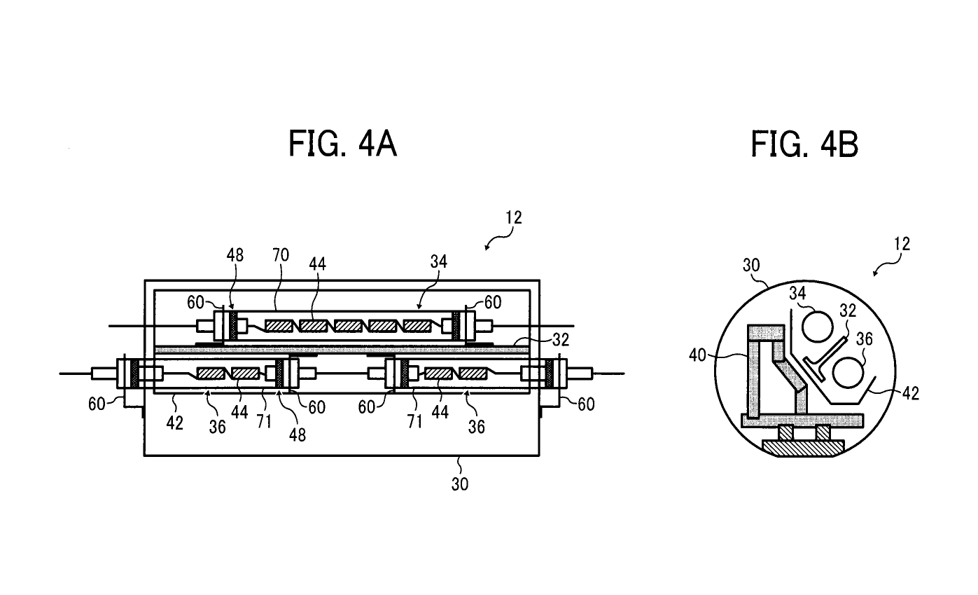

FIG. 4A is a partial horizontal sectional view of the fixing device 12 illustrating the first halogen heater 34 and the second halogen heater 36. FIG. 4B is a partial vertical sectional view of the fixing device 12 that is perpendicular to the horizontal sectional view shown in FIG. 4A.

As shown in FIG. 4A, the first halogen heater 34 serving as the center heater is disposed opposite a center span of the fixing belt 30 in the axial direction thereof. A heater holder 60 serving as a first heater holder situated inside the loop formed by the fixing belt 30 fixedly secures the first halogen heater 34 inside the loop formed by the fixing belt 30. Conversely, the second halogen heater 36 serving as the lateral end heater is disposed opposite each lateral end span of the fixing belt 30 in the axial direction thereof. For example, two separate halogen heaters, that is, a first halogen heater and a second halogen heater, situated at both lateral ends of the fixing belt 30 in the axial direction thereof are electrically connected in series to constitute the second halogen heater 36. The heater holder 60 serving as a second heater holder mounted on each side plate of the fixing device 12 or each flange serving as the holder and the heater holder 60 serving as a second heater holder situated inside the loop formed by the fixing belt 30 fixedly secure the second halogen heater 36 inside the loop formed by the fixing belt 30. A surface of the heater holder 60 is treated with insulation or mirror finish to enhance heating efficiency for heating the fixing belt 30.

As shown in FIG. 4A, the first halogen heater 34 to heat the center span of the fixing belt 30 in the axial direction thereof includes a glass tube 70 not disposed opposite each lateral end span of the fixing belt 30 in the axial direction thereof. Conversely, the second halogen heater 36 to heat each lateral end span of the fixing belt 30 in the axial direction thereof includes a glass tube 71 not disposed opposite the center span of the fixing belt 30 in the axial direction thereof.

The first halogen heater 34 further includes the filament light emitter 44 serving as a heat generator coiled to generate heat and the sealing 48 serving as a support. The glass tube 70 spans substantially a heat generation span of the filament light emitter 44 in the longitudinal direction of the first halogen heater 34. The sealing 48 is disposed in proximity to each lateral end of the filament light emitter 44 in the longitudinal direction of the first halogen heater 34. Similarly, the second halogen heater 36 further includes the filament light emitter 44 serving as a heat generator coiled to generate heat and the sealing 48 serving as a support. The glass tube 71 spans substantially a heat generation span of the filament light emitter 44 in the longitudinal direction of the second halogen heater 36. The sealing 48 is disposed in proximity to each lateral end of the filament light emitter 44 in the longitudinal direction of the second halogen heater 36.

In order to shorten the warm-up time, the thin fixing belt 30 has a thickness in a range of from about 0.1 mm to about 0.3 mm. Contrarily, each of the glass tubes 70 and 71 has a thickness of 1 mm to enhance the mechanical strength and thus is thick compared to the fixing belt 30. Accordingly, each of the glass tubes 70 and 71 has an increased thermal capacity compared to the fixing belt 30. To address this circumstance, the volume of the glass tubes 70 and 71, that is, the length of the glass tubes 70 and 71 in the longitudinal direction of the first halogen heater 34 and the second halogen heater 36, respectively, is decreased to reduce an amount of heat absorbed and consumed by the glass tubes 70 and 71 so that the first halogen heater 34 and the second halogen heater 36 heat the fixing belt 30 effectively.

As shown in FIGS. 4A and 4B, the glass tubes 70 and 71 are heated by light emitted from the filament light emitters 44 and reflected by the reflector 42 and the screen 32 to irradiate the glass tubes 70 and 71 and by heat conducted from the heated fixing belt 30 to the glass tubes 70 and 71 through air (e.g., convection). The shortened glass tubes 70 and 71 advantageously prevent themselves from being heated by such light and heat. The first halogen heater 34 and the second halogen heater 36 having the shortened glass tubes 70 and 71, respectively, and being screened by the screen 32 prevent unnecessary absorption of heat.

A description is provided of a construction of a fixing device 62 according to another exemplary embodiment.

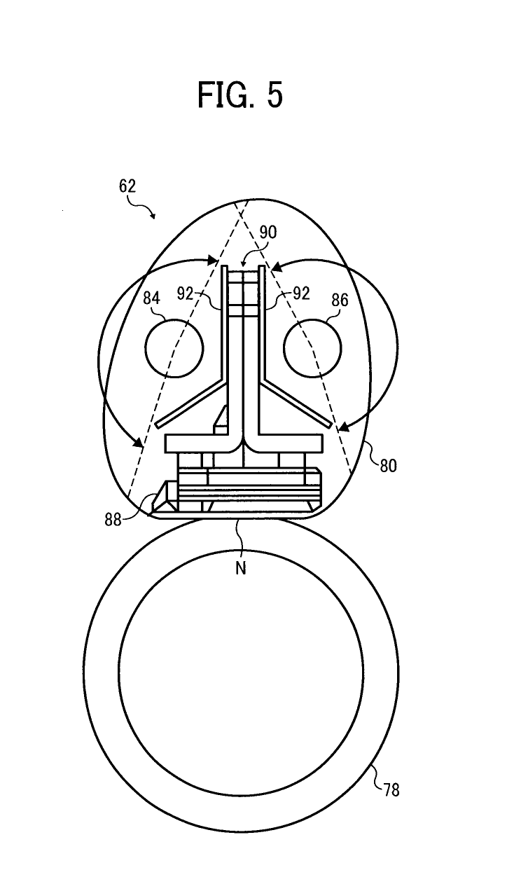

FIG. 5 is a schematic vertical sectional view of the fixing device 62. Like the fixing device 12 depicted in FIG. 2, the fixing device 62 includes a pressure roller 78 serving as a pressure rotator; an endless fixing belt 80 serving as an endless belt or a fixing rotator formed into a loop; and a nip formation pad 88 disposed inside the loop formed by the fixing belt 80 and disposed opposite an inner circumferential surface of the fixing belt 80 to press against the pressure roller 78 via the fixing belt 80 to form a fixing nip N between the fixing belt 80 and the pressure roller 78.

A support 90 (e.g., a stay) supporting the nip formation pad 88 is mounted on and held by a side plate of the fixing device 62 or a flange serving as a holder at each lateral end of the support 90 in a longitudinal direction thereof parallel to an axial direction of the fixing belt 80. The support 90 is elongated vertically in FIG. 5 and T-shaped in cross-section. The support 90 divides an interior inside the loop formed by the fixing belt 80 into a first compartment accommodating a first halogen heater 84 and a second compartment accommodating a second halogen heater 86, preventing the first halogen heater 84 from heating a glass tube of the second halogen heater 86 and preventing the second halogen heater 86 from heating a glass tube of the first halogen heater 84. Thus, the support 90 also serves as a screen that screens the first halogen heater 84 and the second halogen heater 86 from each other.

A stand of the support 90 mounts a reflector 92 at both opposed faces of the support 90 disposed opposite the first halogen heater 84 and the second halogen heater 86, respectively. The reflector 92 shields the support 90 from radiation heat or light from the first halogen heater 84 and the second halogen heater 86. Since the components of the fixing device 62 are equivalent in construction to the components of the fixing device 12 depicted in FIG. 2, a detailed description of the components of the fixing device 62 is omitted.

The first halogen heater 84 and the second halogen heater 86 have different heating spans or different heat distributions, respectively, in a longitudinal direction of the first halogen heater 84 and the second halogen heater 86 parallel to the axial direction of the fixing belt 80. For example, the first halogen heater 84 is a center heater disposed opposite a center span of the fixing belt 80 in the axial direction thereof. The second halogen heater 86 is a lateral end heater disposed opposite each lateral end span of the fixing belt 80 in the axial direction thereof.

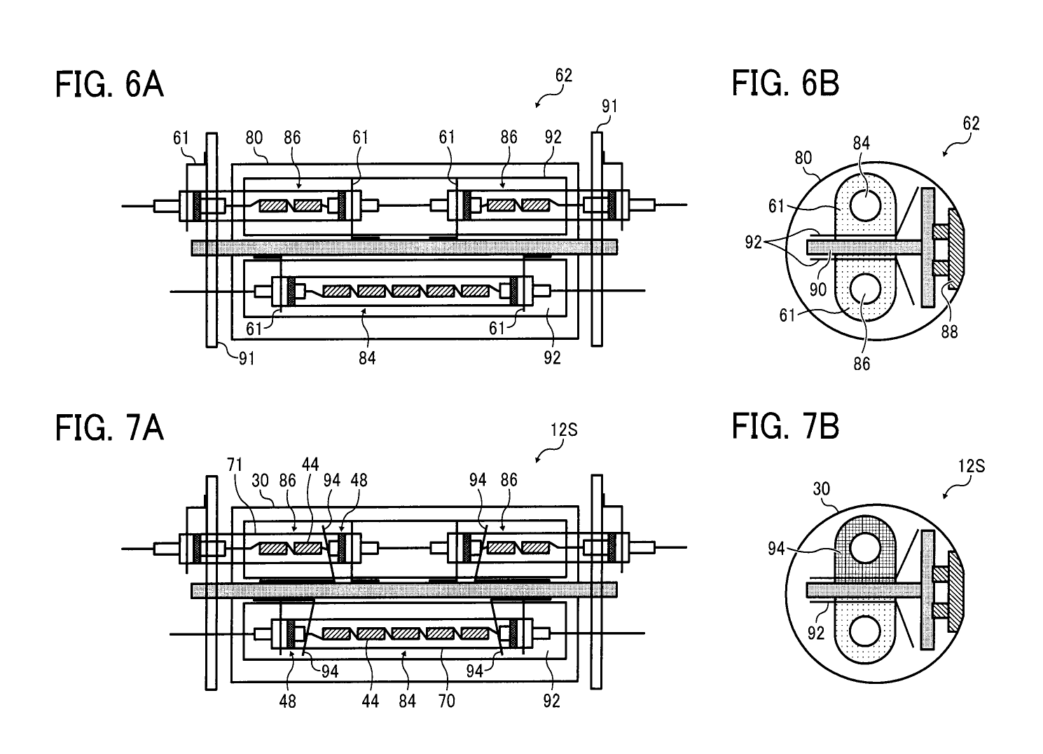

FIG. 6A is a partial horizontal sectional view of the fixing device 62. FIG. 6B is a partial vertical sectional view of the fixing device 62.

As shown in FIG. 6A, the first halogen heater 84 serving as the center heater is disposed opposite the center span of the fixing belt 80 in the axial direction thereof. A heater holder 61 serving as a first heater holder situated inside the loop formed by the fixing belt 80 fixedly secures the first halogen heater 84 inside the loop formed by the fixing belt 80. FIG. 6A is a plan view of the fixing device 62 illustrating the first halogen heater 84 and the second halogen heater 86. Conversely, the second halogen heater 86 serving as the lateral end heater is disposed opposite each lateral end span of the fixing belt 80 in the axial direction thereof. For example, two separate halogen heaters, that is, a first halogen heater and a second halogen heater, situated at both lateral ends of the fixing belt 80 in the axial direction thereof are electrically connected in series to constitute the second halogen heater 86. The heater holder 61 serving as a second heater holder mounted on each side plate 91 of the fixing device 62 and the heater holder 61 serving as a second heater holder situated inside the loop formed by the fixing belt 80 fixedly secure the second halogen heater 86 inside the loop formed by the fixing belt 80.

A description is provided of a construction of a fixing device 12S as a modification example of the fixing devices 12 and 62 depicted in FIGS. 2 and 5, respectively.

FIG. 7A is a partial horizontal sectional view of the fixing device 12S. FIG. 7B is a partial vertical sectional view of the fixing device 12S.

As shown in FIG. 7A, in addition to the components shown in FIG. 6A, the fixing device 12S includes a sealing reflector 94 interposed between the filament light emitter 44 and the sealing 48 of each of the first halogen heater 84 and the second halogen heater 86 in the longitudinal direction of the first halogen heater 84 and the second halogen heater 86 to screen the sealing 48 from the filament light emitter 44. The sealing reflector 94 reflects light emitted from the filament light emitter 44 to prevent the sealing 48 from being heated. The sealing reflector 94 includes an aluminum mirror plate or the like that has an increased reflectance. The sealing reflector 94 is interposed between the filament light emitter 44 and the sealing 48 in the longitudinal direction of the first halogen heater 84 and the second halogen heater 86 to screen the sealing 48 from the filament light emitter 44, thus preventing light emitted from the filament light emitter 44 from heating the sealing 48. The sealing reflector 94 suppresses temperature increase of the sealing 48, extending the life of the first halogen heater 84 and the second halogen heater 86. The sealing reflector 94 is also applicable to the first halogen heater 34 and the second halogen heater 36 depicted in FIG. 4A.

A description is provided of a construction of a fixing device 12T as another modification example of the fixing devices 12 and 62 depicted in FIGS. 2 and 5, respectively.

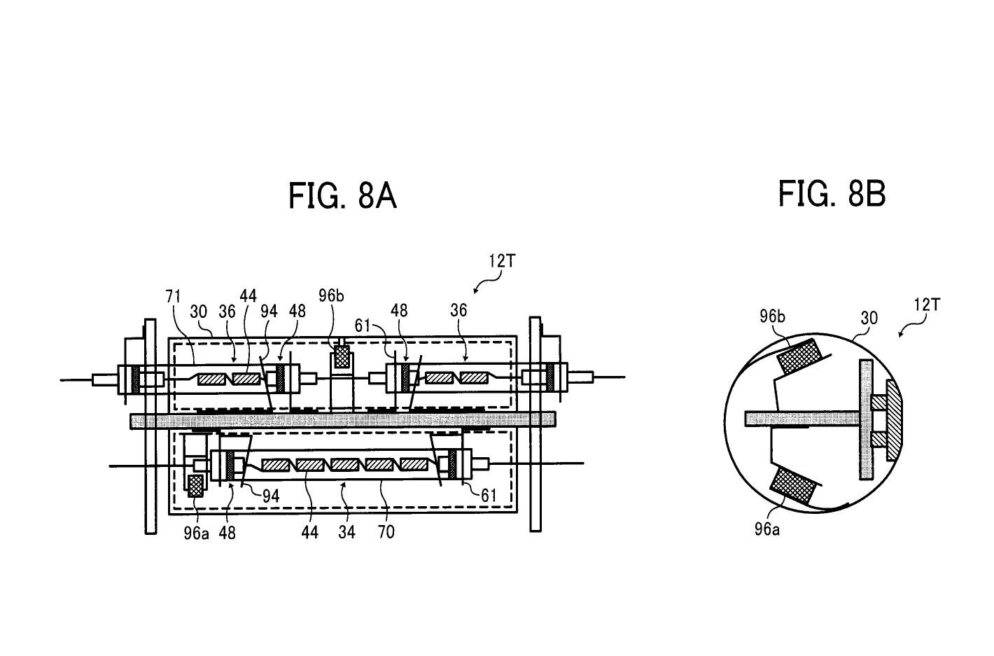

FIG. 8A is a partial horizontal sectional view of the fixing device 12T. FIG. 8B is a partial vertical sectional view of the fixing device 12T.

As shown in FIG. 8A, in addition to the components shown in FIG. 7A, the fixing device 12T includes a plurality of contact thermistors 96a and 96b that contacts the inner circumferential surface of the fixing belt 30 and does not overlap the first halogen heater 34 and the second halogen heater 36 in the longitudinal direction thereof. For example, the contact thermistor 96a serving as a first temperature detector is disposed outboard from the sealing 48 of the first halogen heater 34 serving as the center heater in the longitudinal direction thereof. The contact thermistor 96b serving as a second temperature detector is interposed between two pieces of the center sealing 48 of the second halogen heater 36 serving as the lateral end heater.

The two pieces of the center sealing 48 are disposed opposite the center span of the fixing belt 30 in the axial direction thereof. The heater holder 61 and the sealing reflector 94 screen the contact thermistors 96a and 96b from light emitted from the filament light emitter 44, preventing the contact thermistors 96a and 96b from being heated by the first halogen heater 34 and the second halogen heater 36 directly, enhancing heat resistance of the fixing device 12T.

Additionally, the contact thermistors 96a and 96b do not overlap the glass tubes 70 and 71, respectively, in the longitudinal direction of the first halogen heater 34 and the second halogen heater 36, enhancing flexibility in installation of the contact thermistors 96a and 96b and attaining stable contact of the contact thermistors 96a and 96b with the inner circumferential surface of the fixing belt 30.

Contact thermistors manufactured at reduced costs are typically installed in fixing devices. However, if the contact thermistor contacts the outer circumferential surface of the fixing belt 30, the contact thermistor may produce streaks on the outer circumferential surface of the fixing belt 30. The streaks may be transferred to a toner image T on a sheet P conveyed over the fixing belt 30, forming the faulty toner image T on the sheet P. To address this circumstance, the contact thermistor may contact the inner circumferential surface of the fixing belt 30.

However, if the contact thermistor is installed in a fixing device employing a halogen heater, it is requested to locate the contact thermistor at a position where the contact thermistor is not heated by light emitted from the halogen heater, degrading flexibility in installation of the contact thermistor. For example, if the contact thermistor is installed in a fixing device employing a plurality of halogen heaters, it is difficult to locate the contact thermistor at the position where the contact thermistor is in contact with the inner circumferential surface of the fixing belt 30 and is not heated by light emitted from the halogen heaters.

Although the fixing device 12T depicted in FIG. 8A includes the plurality of halogen heaters, that is, the first halogen heater 34 and the second halogen heater 36, the glass tubes 70 and 71 are shortened in the longitudinal direction of the first halogen heater 34 and the second halogen heater 36, sparing a space where the contact thermistors 96a and 96b contact the inner circumferential surface of the fixing belt 30.

According to the exemplary embodiments described above, the fixing devices 12, 62, 12S, and 12T depicted in FIGS. 2, 5, 7A, and 8A include the two halogen heaters (e.g., the first halogen heater 34 and the second halogen heater 36 or the first halogen heater 84 and the second halogen heater 86). Alternatively, the fixing devices 12, 62, 12S, and 12T may include three or more halogen heaters having different heating spans or different heat distributions, respectively, in a longitudinal direction thereof as a plurality of heaters that heats the fixing belt 30 or 80. The fixing devices 12, 62, 12S, and 12T may include a plurality of heaters of other types, such as ceramic heaters, which generates radiation heat. A screen (e.g., the screen 32 and the support 90) screens the plurality of heaters from each other so that the plurality of heaters does not thermally affect each other with heat radiated from the plurality of heaters. At least one of the glass tubes 70 and 71 of the plurality of heaters is shortened to suppress unnecessary absorption of heat. Hence, various modifications are possible in view of convenience in design and maintenance.

A description is provided of advantages of the fixing devices 12, 62, 12S, and 12T.

As shown in FIGS. 2, 4A, 5, 6A, 7A, and 8A, a fixing device (e.g., the fixing devices 12, 62, 12S, and 12T) includes a fixing rotator or an endless belt (e.g., the fixing belts 30 and 80) rotatable in a predetermined direction of rotation (e.g., the rotation direction D30); a pressure rotator (e.g., the pressure rollers 28 and 78) pressed against an outer circumferential surface of the fixing rotator; a plurality of heaters including a first heater (e.g., the first halogen heaters 34 and 84) and a second heater (e.g., the second halogen heaters 36 and 86) disposed opposite an inner circumferential surface of the fixing rotator; a nip formation pad (e.g., the nip formation pads 38 and 88) disposed opposite the inner circumferential surface of the fixing rotator to press against the pressure rotator via the fixing rotator to form the fixing nip N between the fixing rotator and the pressure rotator; and a screen (e.g., the screen 32 and the support 90) interposed between the first heater and the second heater to screen one of the first heater and the second heater from another one of the first heater and the second heater.

The first heater includes a first heat generator (e.g., the filament light emitter 44) having a first heating span in a longitudinal direction of the first heater to generate heat and a first support (e.g., the sealing 48) that supports the first heat generator. The second heater includes a second heat generator (e.g., the filament light emitter 44) having a second heating span in a longitudinal direction of the second heater to generate heat and a second support (e.g., the sealing 48) that supports the second heat generator. The first heating span of the first heat generator is different from the second heating span of the second heat generator in the longitudinal direction of the first heater and the second heater. At least one of the first support and the second support is disposed in proximity to a lateral end of at least one of the first heat generator and the second heat generator in the longitudinal direction of the first heater and the second heater.

Accordingly, the first heater and the second heater do not heat each other and do not heat a part of the first heater and the second heater unnecessarily, preventing the shortened life of the first heater and the second heater.

Additionally, the first heater and the second heater having the different heating spans or the different heat distributions, respectively, reduce unnecessary heat absorption, saving energy.

According to the exemplary embodiments described above, the fixing belts 30 and 80 serve as a fixing rotator. Alternatively, a fixing roller, a fixing film, a fixing sleeve, or the like may be used as a fixing rotator. Further, the pressure rollers 28 and 78 serve as a pressure rotator. Alternatively, a pressure belt or the like may be used as a pressure rotator.

The present disclosure has been described above with reference to specific exemplary embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. A fixing device comprising:
a fixing rotator rotatable in a predetermined direction of rotation;
a pressure rotator pressed against the fixing rotator to form a fixing nip therebetween, through which a recording medium bearing a toner image is conveyed;
a first heater disposed opposite an inner circumferential surface of the fixing rotator to heat the fixing rotator,
the first heater including:
a first heat generator having a first heating span in a longitudinal direction of the first heater to generate heat; and
a first support supporting the first heat generator;
a second heater disposed opposite the inner circumferential surface of the fixing rotator to heat the fixing rotator,
the second heater including:
a second heat generator having a second heating span in a longitudinal direction of the second heater to generate heat; and
a second support supporting the second heat generator; and
a screen interposed between the first heater and the second heater to screen one of the first heater and the second heater from another one of the first heater and the second heater,
at least one of the first support and the second support being disposed in proximity to a lateral end of at least one of the first heat generator and the second heat generator in the longitudinal direction of the first heater and the second heater.

2. The fixing device according to claim 1, wherein each of the first heater and the second heater further includes a halogen heater.

3. The fixing device according to claim 1, wherein each of the first heat generator and the second heat generator includes a filament light emitter and each of the first support and the second support includes a sealing.

4. The fixing device according to claim 3, wherein each of the first heater and the second heater further includes a glass tube accommodating the filament light emitter and being equivalent in length to the filament light emitter in the longitudinal direction of the first heater and the second heater.

5. The fixing device according to claim 4, wherein the sealing is disposed at each lateral end of the glass tube in the longitudinal direction of the first heater and the second heater.

6. The fixing device according to claim 5, further comprising a sealing reflector interposed between the filament light emitter and the sealing in the longitudinal direction of the first heater and the second heater to screen the sealing from the filament light emitter.

7. The fixing device according to claim 3,
wherein the first heating span of the first heater is a center span of the fixing rotator in an axial direction thereof, and
wherein the second heating span of the second heater is a lateral end span of the fixing rotator in the axial direction thereof.

8. The fixing device according to claim 7, further comprising a first temperature detector contacting the inner circumferential surface of the fixing rotator to detect a temperature of the fixing rotator and being disposed outboard from the sealing of the first heater in the longitudinal direction of the first heater.

9. The fixing device according to claim 8, wherein the first temperature detector includes a thermistor.

10. The fixing device according to claim 8, further comprising a first heater holder to hold the first heater, the first heater holder interposed between the filament light emitter of the first heater and the first temperature detector in the longitudinal direction of the first heater to screen the first temperature detector from the filament light emitter of the first heater.

11. The fixing device according to claim 10, wherein the first heater holder is disposed inside the fixing rotator.

12. The fixing device according to claim 7, wherein the second heater further includes:
a first halogen heater; and
a second halogen heater electrically connected in series to the first halogen heater.

13. The fixing device according to claim 12, further comprising a second temperature detector contacting the inner circumferential surface of the fixing rotator to detect a temperature of the fixing rotator and being interposed between the first halogen heater and the second halogen heater in the longitudinal direction of the second heater.

14. The fixing device according to claim 13,
wherein each of the first halogen heater and the second halogen heater includes a center sealing disposed opposite the center span of the fixing rotator in the axial direction thereof, and
wherein the second temperature detector is interposed between the center sealing of the first halogen heater and the center sealing of the second halogen heater in the longitudinal direction of the second heater.

15. The fixing device according to claim 13, further comprising a second heater holder to hold the second heater, the second heater holder interposed between the filament light emitter of the second heater and the second temperature detector in the longitudinal direction of the second heater to screen the second temperature detector from the filament light emitter of the second heater.

16. The fixing device according to claim 13, wherein the second temperature detector includes a thermistor.

17. The fixing device according to claim 1, wherein the fixing rotator includes an endless belt.

18. The fixing device according to claim 17, further comprising a nip formation pad to press against the pressure rotator via the endless belt to form the fixing nip.

19. An image forming apparatus comprising:
an image bearer to bear a toner image; and
a fixing device disposed downstream from the image bearer in a recording medium conveyance direction to fix the toner image on a recording medium,
the fixing device including:
a fixing rotator rotatable in a predetermined direction of rotation;
a pressure rotator pressed against the fixing rotator to form a fixing nip therebetween, through which the recording medium bearing the toner image is conveyed;
a first heater disposed opposite an inner circumferential surface of the fixing rotator to heat the fixing rotator,
the first heater including:
a first heat generator having a first heating span in a longitudinal direction of the first heater to generate heat; and
a first support supporting the first heat generator;
a second heater disposed opposite the inner circumferential surface of the fixing rotator to heat the fixing rotator,
the second heater including:
a second heat generator having a second heating span in a longitudinal direction of the second heater to generate heat; and
a second support supporting the second heat generator; and
a screen interposed between the first heater and the second heater to screen one of the first heater and the second heater from another one of the first heater and the second heater,
at least one of the first support and the second support being disposed in proximity to a lateral end of at least one of the first heat generator and the second heat generator in the longitudinal direction of the first heater and the second heater.
